(19) United States
(12) Patent Application Publication
(10) Pub. No.: US 2026/0203622 A1
(43) Pub. Date: Jul. 16, 2026

(54) SYSTEMS AND METHODS FOR IMPLEMENTING A STOCHASTIC ISING MACHINE

(71) Applicant: ECOLE POLYTECHNIQUE DE MONTREAL, Montreal (CA)

(72) Inventor: Tarek OULD-BACHIR, Quebec (CA)

(21) Appl. No.: 19/549,674

(22) Filed: Feb. 25, 2026

Related U.S. Application Data
(63) Continuation of application No. PCT/IB2024/058243, filed on Aug. 23, 2024.
(60) Provisional application No. 63/578,842, filed on Aug. 25, 2023.

(51) Int. Cl. G06N 7/01

(52) U.S. Cl. CPC G06N 7/01

(57) ABSTRACT

A computer-implemented method and systems for modeling a stochastic Ising model including a plurality of binary nodes are disclosed. The method includes defining a set of interaction coefficients indicative of interaction between the plurality of binary nodes, defining a convergence coefficient based on the set of interaction coefficients, defining an initial state of the stochastic Ising model, iteratively determining, for each binary node, a node state probability indicative of a state of the binary node at a given iteration of the stochastic Ising model based on the set of interaction coefficients, the convergence coefficient, states of the other binary nodes at a previous iteration, and the node state probability of the given binary node at the previous iteration and determining saturation values of the node state probabilities of the plurality of binary nodes.

### CROSS-REFERENCE TO RELATED APPLICATIONS

The present application is continuation of PCT Patent Application No. PCT/IB2024/058243, with an international filing date of Aug. 23, 2024, which claims priority to U.S. Provisional Patent Application No. 63/578,842 filed on Aug. 25, 2023, the entire disclosure of which is incorporated herein by reference.

### TECHNICAL FIELD

The present disclosure relates generally to the field of computer model optimization, and more specifically to the implementation of a stochastic Ising machine.

### BACKGROUND

Optimization of complex systems in various application fields such as physics, finance, logistics, control, and chemistry often results in mathematical combinatorial optimization problems. The Ising model is a known stochastic mathematical model that provides solutions to complex optimization systems, the specific purpose device being called an Ising machine. For example, the Ising model is used to model ferromagnetism, which is the natural organization of particles organization of the particles of certain metals that creates a permanent magnetization in a given direction. In this example, said given direction is indicative of a fundamental state resulting from a global optimization of matter in a complex context of multiple interactions between magnetic particles.

As another example, the problem of the travelling salesman may be solved using an Ising model. As yet another example, partitioning problems consisting of distributing blocks of information of various sizes between two identical memory spaces may also be modeled by the Ising model. The problem of searching for the ground state of the Ising model is called an Ising problem and is described by an Hamiltonian function to be minimized:

$$H = {\sum }_{i = 1}^{n} {h}_{i} {σ}_{i} + {\sum }_{i = 1}^{n} {\sum }_{j = 1}^{n} {J}_{i j} {σ}_{i} {σ}_{j} \qquad ( 1 )$$

where σᵢ,σⱼ∈{−1, +1} represent binary nodes of the Ising machine and account for spins of the nodes, n is a number of binary nodes, hi accounts for an external magnetic filed applied to the node i, and Jᵢⱼ accounts for magnetic coupling between nodes i and j (with Jᵢⱼ=Jⱼᵢ and Jᵢᵢ=0). Artificial binary nodes may be added in the model to account for external magnetic filed components such that the Hamiltonian function may include a single sum

$$( i . e . H = {\sum }_{i = 1}^{n} {\sum }_{j = 1}^{n} {J}_{i j} {σ}_{i} {σ}_{j} ) .$$

In recent years, specific purpose devices that perform a search process for the ground state of an Ising model have been attracting attention. However, even though some implementations of Ising machines exist, they rely on non-mature technologies and are not suitable to be scaled to any number of binary nodes.

There is thus an interest in developing systems and methods for implementing an Ising machine that may be easily scaled and deployed on conventional digital technology.

### SUMMARY

The implementations of the present disclosure have been developed based on developers' appreciation of the limitations associated with the prior art. Developers of the present technology have devised methods and systems for implementing a stochastic Ising machine on conventional digital technology.

In accordance with a first broad aspect of the present disclosure, there is provided a computer-implemented method for modeling a stochastic Ising model comprising a plurality of binary nodes. The method includes defining a set of interaction coefficients indicative of interaction between the plurality of binary nodes, defining an initial state of the stochastic Ising model, iteratively determining, for each binary node, a node state probability indicative of a state of the binary node at a given iteration of the stochastic Ising model based on the set of interaction coefficients, the convergence coefficient, states of the other binary nodes at a previous iteration, and the node state probability of the given binary node at the previous iteration and determining saturation values of the node state probabilities of the plurality of binary nodes.

In some non-limiting implementations, determining a node state probability comprises, at each iteration and for each binary node, generating, by a random number generator, a random integer and multiplexing the random integer with the node state probability of the given binary node at the previous iteration to obtain the node state probability.

In some non-limiting implementations, the random integer is generated following a uniform probability distribution.

In some non-limiting implementations, the random number generator is a Combined Tausworthe generator.

In some non-limiting implementations, the method further includes, prior to multiplexing the random integer with the node state probability of the given binary node at the previous iteration, extracting, by a priority encoder, a binary representation of an index of a most significant bit of the output of the random number generator to adjust the random integer and multiplexing the adjusted random integer with the node state probability of the given binary node at the previous iteration to obtain the node state probability.

In some non-limiting implementations, the memory is further configured to store information about a convergence coefficient defined based on the set of interaction coefficients.

In some non-limiting implementations, determining a node state probability includes, at each iteration and for each binary node, collecting bit values of the other binary nodes, multiplying the convergence coefficient and the interaction coefficients to corresponding bit values, summing an inverse of the obtained products and summing the node state probability of the given binary node at the previous iteration to the sum of inverse products.

In some non-limiting implementations, the method further includes, subsequent to adding the node state probability of the given binary node at the previous iteration, applying a linear saturation function to the sum.

In some non-limiting implementations, the method further includes, prior to iteratively determining a node state probability for each binary node, defining a plurality of node clusters, each node cluster comprising a subset of the binary nodes, the node clusters having a same number of binary nodes. Determining a node state probability includes, within each node cluster, generating, at each iteration, a random integer by a random number generator, each random integer being associated with binary nodes of the node cluster and once the random number generator of the node cluster has generated a random integer for each binary node of the node cluster, multiplexing, for each binary node of the node cluster, a corresponding random integer with the node state probability of the given binary node at the previous iteration to obtain the node state probability.

In some non-limiting implementations, defining an initial state of the stochastic Ising model comprises assigning the node state probabilities to a pre-determined probability value.

In accordance with a second broad aspect of the present disclosure, there is provided a stochastic Ising machine for numeric modeling a stochastic Ising model including a plurality of binary nodes, the application-specific hardware equipment including a processor configured to associate each binary node with a node state probability indicative of a state of the binary node at a given iteration, a memory communicably connected to the processor and configured to store information about a set of interaction coefficients indicative of interaction between the plurality of binary nodes and an initial state of the stochastic Ising model by assigning an initial bit value to each of the binary node. The stochastic Ising machine further includes one or more random number generators operated by the processor and configured to generate random integers, one or more multiplexing modules, each multiplexing module being configured to iteratively multiplex a random integer, generated by a random number generator associated with the multiplexer, with the node state probability of a corresponding binary node at the previous iteration to obtain the node state probability of the corresponding node.

In some non-limiting implementations, the one or more random number generators rely on a uniform probability distribution to generate the random integers.

In some non-limiting implementations, the one or more random number generator are Combined Tausworthe generators.

In some non-limiting implementations, each random number generator further comprises a priority encoder configured to generate a binary representation of an index of a most significant bit of the random integer, the multiplexer associated with the random number generator being configured to multiplex the binary representation with the node state probability of the corresponding node at the previous iteration to obtain the node state probability thereof.

In some non-limiting implementations, the memory is further configured to store information about a convergence coefficient defined based on the set of interaction coefficients.

In some non-limiting implementations, the processor further, for each binary node, collects bit values of the other binary nodes, applies the convergence coefficient and the interaction coefficients to corresponding bit values to obtain interaction values, sums an inverse of the interaction values and sums the node state probability of the given binary node at the previous iteration to the sum of inverse interaction values.

In some non-limiting implementations, the processor further, for each binary node and subsequent to adding the node state probability of the given binary node at the previous iteration, applies a linear saturation function to the sum.

In some non-limiting implementations, the processor further defines a plurality of node clusters, each node cluster comprising a subset of the binary nodes, the node clusters having a same number of binary nodes, causes, at each iteration, a given random number generator of the one or more random number generators, to generate a random integer and, once the random number generator has generated a random integer for each binary node of a corresponding node cluster, causes multiplexers of the binary nodes of the node cluster to multiplex a corresponding random integer with the node state probability of the corresponding binary node at a previous iteration to obtain the node state probability.

In some non-limiting implementations, the stochastic Ising machine further includes a plurality of memory units communicably connected with the processor, each memory unit being configured to store an interaction coefficient of a first node on a second node.

In some non-limiting implementations, the plurality of memory units are Random-Access Memory units.

In some non-limiting implementations, the plurality of memory units are portions of the main memory.

In accordance with a third broad aspect of the present disclosure, there is provided a stochastic Ising machine for numeric modeling a stochastic Ising model including a plurality of binary nodes, the application-specific hardware equipment comprising a processor and a memory storing a plurality of executable instructions which, when executed by the processor, cause the application-specific hardware equipment to perform any one of the methods disclosed herein.

In accordance with a fourth broad aspect of the present disclosure, there is provided a non-transitory computer-readable medium comprising computer-readable instructions that, upon being executed by a system, cause the system to perform any one of the methods disclosed herein.

### BRIEF DESCRIPTION OF THE FIGURES

Further features and advantages of the present disclosure will become apparent from the following detailed description, taken in combination with the appended drawings, in which:

FIG. 1 is an illustrative representation of an Ising model including five nodes;

FIG. 2 is a schematic representation of an Ising machine in accordance with various non-limiting implementations of the present disclosure;

FIG. 3 is another schematic representation of the Ising machine of FIG. 2 in accordance with various non-limiting implementations of the present disclosure;

FIG. 4 is a schematic representation of a Dedicated Random Number Generating module of the Ising machine of FIG. 3 in accordance with various non-limiting implementations of the present disclosure;

FIG. 5 is a schematic representation of a unit of a Weight Stochastic Updating module of the Ising machine of FIG. 3 in accordance with various non-limiting implementations of the present disclosure;

FIG. 6 shows experimental results of an execution of the Ising machine of FIG. 3 in accordance with various non-limiting implementations of the present disclosure;

FIG. 7 is a schematic representation of a stochastic Ising machine in accordance with other various non-limiting implementations of the present disclosure;

FIGS. 8A and 8B are schematic representations of transmission of information between node clusters of the stochastic Ising machine of FIG. 7;

FIG. 9 is a block diagram of a node cluster of the stochastic Ising machine of FIG. 7 in accordance with various non-limiting implementations of the present disclosure;

FIG. 10 is a block diagram of an updating unit of the node cluster of FIG. 8 in accordance with various non-limiting implementations of the present disclosure;

FIG. 11 is a flow diagram showing operations of a method for modeling a stochastic Ising model in accordance with various non-limiting implementations of the present disclosure;

FIG. 12 is a block diagram of an electronic device for implementing a stochastic Ising machine in accordance with various non-limiting implementations of the present disclosure; and

FIG. 13 shows a chart of a saturation function used in the unit of FIG. 5 in accordance with various non-limiting implementations of the present disclosure.

It is to be understood that throughout the appended drawings and corresponding descriptions, like features are identified by like reference characters. Furthermore, it is also to be understood that the drawings and ensuing descriptions are intended for illustrative purposes only and that such disclosures do not provide a limitation on the scope of the claims.

### DETAILED DESCRIPTION

The instant disclosure is directed to address at least some of the deficiencies of the current technology. In particular, the instant disclosure describes a system and a method for modeling a stochastic Ising model comprising a plurality of binary nodes.

As used herein, the term “about” or “approximately” refers to a +/−10% variation from the nominal value. It is to be understood that such a variation is always included in a given value provided herein whether or not it is specifically referred to.

Unless otherwise defined or indicated by context, all technical and scientific terms used herein have the same meaning as commonly understood by one of ordinary skill in the art to which the described implementations appertain to.

In the context of the present specification, unless provided expressly otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first processor” and “third processor” is not intended to imply any particular order, type, chronology, hierarchy or ranking (for example) of/between the processor, nor is their use (by itself) intended to imply that any “second processor” must necessarily exist in any given situation. Further, as is discussed herein in other contexts, reference to a “first” element and a “second” element does not preclude the two elements from being the same actual real-world element. Thus, for example, in some instances, a “first” processor and a “second” processor may be the same software and/or hardware, in other cases they may be different software and/or hardware.

It will be understood that when an element is referred to as being “connected” or “coupled” to another element, it can be directly or indirectly connected or coupled to the other element or intervening elements that may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In the context of the present specification, when an element is referred to as being “associated with” another element, in certain implementations, the two elements can be directly or indirectly linked, related, connected, coupled, the second element employs the first element, or the like without limiting the scope of the present disclosure.

In the context of the present disclosure, a Ising machine is a hardware device which aims at finding the absolute or approximate ground states of an Ising model. As it will be described in greater details hereinafter, a Ising model includes a plurality of binary nodes, each binary node i being associated with a state (or “spin”) σᵢ∈{−1; +1}. In use, the state of the binary node i is mapped in a corresponding node bit value bᵢ∈{0; 1}, where bᵢ=0 in response to σᵢ=−1 and bᵢ=1 in response to σᵢ=+1. In an aspect, the present technology provides a stochastic approach to the Ising model in which a state probability of each node to be in a first state (i.e. σᵢ=−1) or in a second state (i.e. σᵢ=+1) temporally varies.

The terminology used herein is only intended to describe particular representative implementations and is not intended to be limiting of the present technology. As used herein, the singular forms “a,” “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some implementations of the present technology, the processor may be a general-purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

In the context of the present disclosure, the expression “data” includes data of any nature or kind whatsoever capable of being stored in a database. Thus, data includes, but is not limited to, audiovisual works (images, movies, sound records, presentations, etc.), data (location data, numerical data, etc.), text (opinions, comments, questions, messages, etc.), documents, spreadsheets, etc.

Software modules, modules, or units which are implied to be software, may be represented herein as any combination of flowchart elements or other elements indicating performance of process steps and/or textual description. Such modules may be executed by hardware that is expressly or implicitly shown.

With these fundamentals in place, the instant disclosure is directed to address at least some of the deficiencies of the current technology. In particular, the instant disclosure describes a system and a method for modeling a stochastic Ising model comprising a plurality of binary nodes.

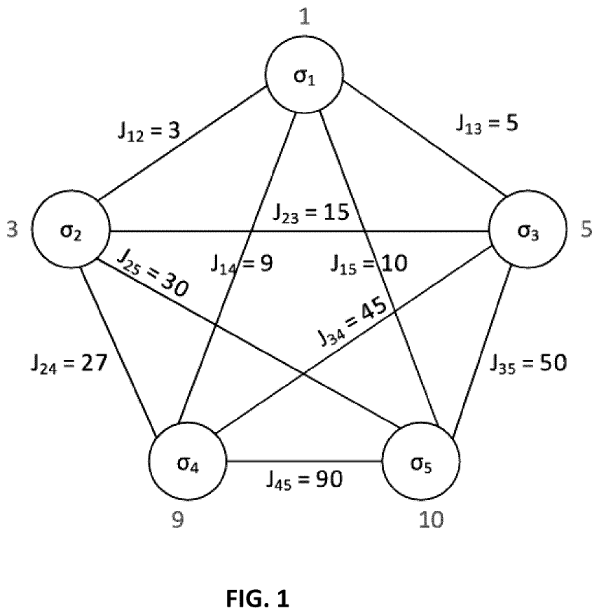

FIG. 1 shows an example of a Ising model 10 including five binary nodes having corresponding states σ₁, σ₂, σ₃, σ₄ and σ₅. Each binary node i has a corresponding coupling coefficient Jᵢⱼ with all of the other binary node j≠i. The coupling coefficients Jᵢⱼ may be pre-determined based on an optimization problem to be solved.

In this illustrative example, the Hamiltonian function is minimized for {σ₁, σ₂, σ₃, σ₄, σ₄}={−1,−1,+1,+1,−1} and {σ₁,σ₂,σ₃,σ₄,σ₄}={+1,+1,−1,−1,+1} and is equal to −108. The states of the binary nodes of the Ising model when the Hamiltonian function is minimized correspond to an idle state of the Ising model. These states of the binary nodes correspond to a solution of the optimization problem represented by the Ising model 10. Broadly speaking, an Ising machine will tend to minimize its energy and will “naturally” reach its rest state, thus producing the solution to the optimization problem.

The developers of the present technology have devised an Ising model (and an Ising machine for executing said Ising model) that involves a stochastic approach. As such, said Ising model and the corresponding Ising machine may be referred to a stochastic Ising model and a corresponding stochastic Ising machine respectively. More specifically, in this implementation, each spin σᵢ is associated with a node state probability pᵢ to be equal to +1. In other words, the node state probability pᵢ may be defined as:

$${p}_{i} = P ( {σ}_{i} = + 1 ) = P ( {b}_{i} = + 1 ) = 1 - P ( {σ}_{i} = - 1 ) = 1 - P ( {b}_{i} = 0 ) .$$

As will be described in greater details hereinafter, the stochastic Ising model iteratively determines the node state probability pᵢ for each node i, said probability depending on coupling coefficients according to the following relationship:

$${p}_{i}^{+} = P ( {σ}_{i} = + 1 \vert {σ}_{j , j \neq i} ) = φ ( {p}_{i} - γ {\sum }_{j = 1}^{n} {J}_{i j} {σ}_{j} ) \qquad ( 2 )$$

$$where {p}_{i}^{+}$$

is the updated node state probability, at the following iteration of the stochastic Ising model, for having σᵢ=+1, γ is a pre-determined convergence coefficient for controlling a speed of convergence of the stochastic Ising model and φ(⋅) is a saturation function aiming at constraining

$${p}_{i}^{+}$$

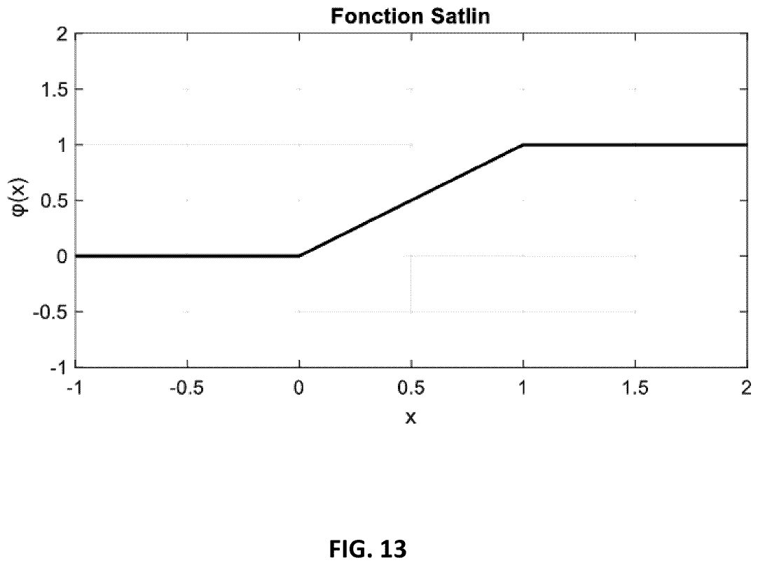

in the range [0,1]. A non-limitative example of a chart of the saturation function φ(⋅) is shown on FIG. 13. It can thus be said that the status of the spins σᵢ sampled are used to update their probabilities

$${p}_{i}^{+}$$

In the next step, according to equation (2).

In the context of the present disclosure, a stable state of a binary node is a state that the binary node keeps along iteration of the stochastic Ising model Given equation

$$( i . e . {p}_{i} = {p}_{i}^{+} ) .$$

Given equation (2), a stable state of a binary node i is reached in response to one of the following conditions is satisfied:

$$\{ \begin{matrix}If {p}_{i} = {\overline{p}}_{ι} and {p}_{i} = 1 , 0 , then {σ}_{i} = + 1 and {\sum }_{j = 1}^{n} {J}_{ij} {σ}_{j} < 0 ; \\ If {p}_{i} = {\overline{p}}_{ι} and {p}_{i} = 0 , 0 , then {σ}_{i} = - 1 and {\sum }_{j = 1}^{n} {J}_{ij} {σ}_{j} < 0 , \\ Else {\sum }_{j = 1}^{n} {J}_{ij} {σ}_{j} = 0\end{matrix} . \qquad ( 3 )$$

In other words, a stable state of the binary node i is reached when pᵢ is saturated at a limit corresponding to the state, and

$${\sum }_{j = 1}^{n} {J}_{i j} {σ}_{j} < 0 .$$

Saturation of the node state probability pᵢ is reached when it has reached one of two extreme values 0.0 or 1.0. The saturated node state probability pᵢ may be denoted p̅ₗ. When the node state probability pris saturated (pᵢ=p̅ₗ), the status of the sampled spin σᵢ is predetermined and equals σ̅ₗ=2p̅ₗ−1 where σ̅ₗ is the spin associated with the saturated probability p̅ₗ. Also in the context of the present disclosure, a stable state of the stochastic Ising model is reached when each binary node has reached a respective stable state. The state of a stochastic Ising model including N binary nodes may be noted p={p₁, p₂, . . . , p_{N}}. The stable state of the stochastic Ising model is thus reached in response to p=p⁺.

In use, the stochastic Ising model is executed by performing several iterations during which the spin states are sampled according to their respective node state probability. In an implementation, an initial state of the Ising model is defined by assigning the node state probabilities of each binary node to a pre-defined initial node state probability value (e.g. 0.5). At each iteration of the stochastic Ising model, a current state of the stochastic Ising model is used to determine a following state of the stochastic Ising model. More specifically, each iteration includes a sampling of the states of the binary nodes, and an update of the node state probability based on said sampling. As will be described in greater details herein after, the stochastic Ising model may be expected to converge towards a stable state that corresponds to the minimum of the Hamiltonian, or at least a local minimum.

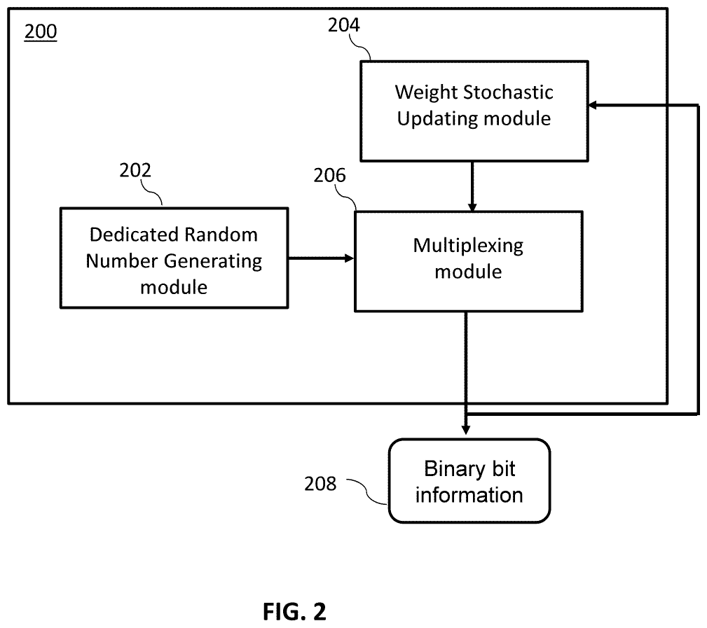

FIG. 2 is a schematic representation of an Ising machine 200 in accordance with various non-limiting implementations of the present disclosure. In an implementation, the Ising machine 200 includes a Dedicated Random Number Generating module 202 for generating random numbers, a Weight Stochastic Updating module 204 for updating node probabilities, and a Multiplexing module 206 for multiplexing outputs of the Dedicated Random Number Generating module 202 and the Weight Stochastic Updating module 204 to generate binary bit information 208 indicative of states of the binary nodes.

More specifically, the Dedicated Random Number Generating module 202 generates, at each iteration of the stochastic Ising model and for each binary nodes thereof, a random number as described herein after. For each binary node, the corresponding random number is used, by the multiplexing module 206, to weight the node state probability pᵢ in order to determine the updated node state probability

$${p}_{i}^{+}$$

based on outputs of the weight Stochastic Updating module 204.

In an implementation, the binary bit information 108 includes the updated node state probability

$${p}_{i}^{+}$$

of each binary node of the stochastic Ising machine 200. Said binary bit information 108 may be further redirected to the Weight Stochastic Updating module 204 to determine the node state probabilities at a subsequent iteration of the stochastic Ising model.

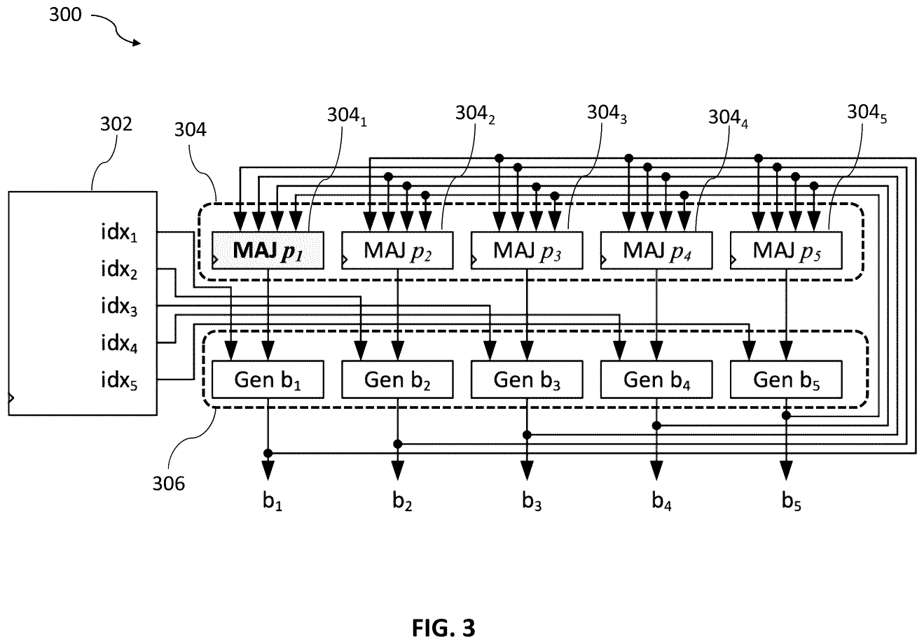

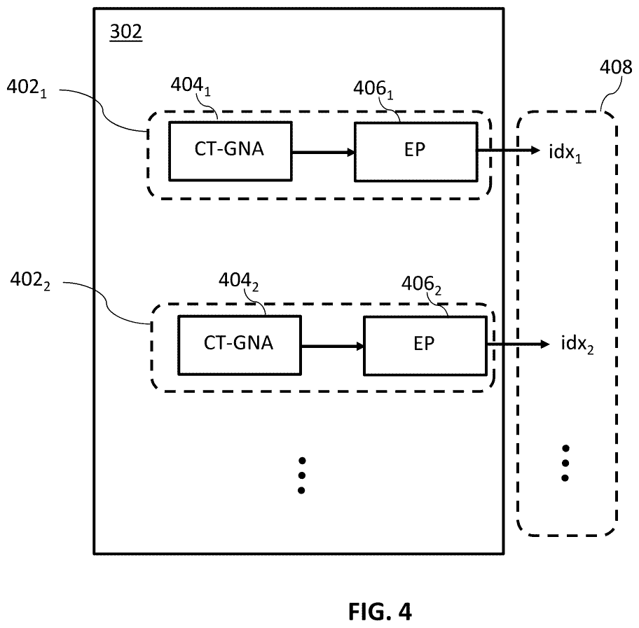

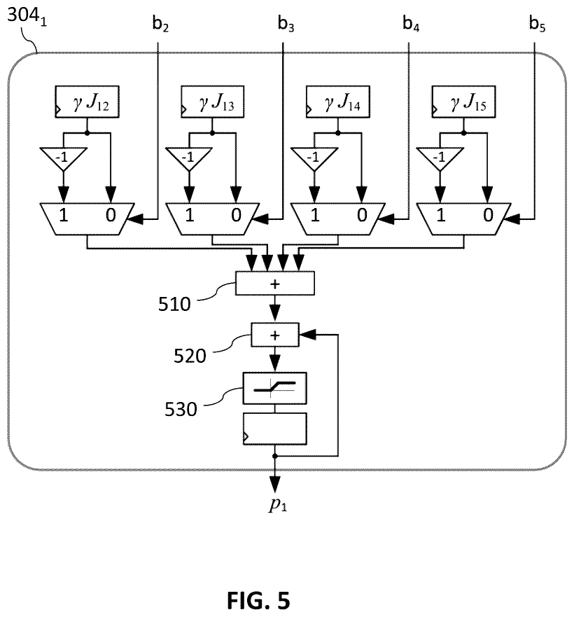

More specifically, with reference to FIG. 3, an illustrative example of a stochastic Ising machine 300 including five nodes is depicted. In use, a Dedicated Random Number Generating module 302 of the stochastic Ising machine 300 generates, at each iteration, a set of five random numbers 408 denoted “idx₁, idx₂, idx₃, idx₄ and idx₅”. As best shown on FIG. 4, the Dedicated Random Number Generating module 302 may include a stochastic number generator (SNG) 402; for each binary node of the stochastic Ising model. In this implementation, the SNGs generates each of the random numbers 408 according to a same uniform probability distribution. For example and without limitations, each SNG 402ᵢ may include a Combined Tausworthe (CT) random number generator (RNG) 404ᵢ to generate a corresponding random number 408. Other types of RNG are also contemplated, this aspect is not limitative. For example, the RNG 404ᵢ may be a linear feedback shift register (LFSR)-based generator or a Mersenne Twister generator. Each SNG 402ᵢ further includes a priority encoder 406ᵢ that, in use, receives an output of the corresponding RNG 404ᵢ. The priority encoder 406ᵢ may collaborate with the corresponding RNG 404ᵢ as described in “A new hardware architecture for sampling the exponential distribution”, by Tarek Ould Bachir, Mohamad Sawan, and Jean-Jules Brault, published in Canadian Conference on Electrical and Computer Engineering in May 2008, the entirety of which is incorporated by reference. The stochastic Ising machine 300 further includes a Weight Stochastic Updating module 304 including an updating unit 304ᵢ for updating the node state probability pᵢ of a corresponding binary node i, a non-limiting implementation of the updating unit 304₁ for determining pᵢ at each iteration of the stochastic Ising model being depicted on FIG. 5. In this implementation, the pre-determined convergence coefficient γ and the interaction coefficients Jᵢⱼ for the node 1 relative to the other binary nodes (namely J₁₂, J₁₃, J₁₄ and J₁₅ in this example) are stored in the updating unit 304₁. Each of the node bit values b₂, b₃, b₄ and b₅ of a current iteration of the stochastic Ising model are collected and received by updating unit 304₁ and multiplied by the corresponding interaction coefficient and the pre-determined convergence coefficient γ. Each value γJᵢⱼ may be referred to as a corrected interaction coefficient.

The obtained terms are added at operation 510, thus determining the sum

$$- γ {\sum }_{j = 2}^{5} {J}_{1 j} {b}_{j} .$$

It can be said that the higher the pre-determined convergence coefficient γ, the faster the node state probabilities will converge toward respective limit values. It should be noted that if the node state probabilities converge too fast (i.e. the pre-determined convergence coefficient γ is too high), the limit values may not correspond to a solution of the optimization problem to be solved. For example and without limitation, the pre-determined convergence coefficient γ may be arbitrarily set to 1. In some implementations, the pre-determined convergence coefficient γ is determined based on the interaction coefficients Jᵢⱼ. In one implementation, the pre-determined convergence coefficient γ is proportional to

$$\frac{1}{{max ( \vert {J}_{i j} \vert )}_{i , j}} ( e . g . γ = \frac{0 , 01}{{max ( \vert {J}_{i j} \vert )}_{i , j}} ) .$$

In the same or other implementations, the pre-determined convergence coefficient γ may be dynamically adjusted while the node state probabilities are being updated. For example and without limitations, the pre-determined convergence coefficient γ may be increased by 20 percent in response 100 iterations of the stochastic Ising machine 300 being completed.

At operation 520, the node state probability of the node 1 at the current iteration is added to the sum, thereby obtaining:

$${p}_{1} - γ {\sum }_{j = 2}^{5} {J}_{1 j} {b}_{j} .$$

The saturation function is further applied at operation 530 to obtain the updated node state probability:

$${p}_{i}^{+} = φ ( {p}_{i} - γ {\sum }_{j = 1}^{n} {J}_{i j} {σ}_{j} )$$

The same operations are executed, in parallel or in series, for the other binary nodes of the stochastic Ising machine 300.

The updated node state probability of each binary node is further multiplexed by the corresponding random number generated by the Dedicated Random Number Generating module 302 at the Multiplexing module 306. The multiplexing module 306 thus outputs updated bit values, based on the updated node state probabilities, indicative of an updated node state of the binary nodes of the stochastic Ising machine 300 at the following iteration thereof.

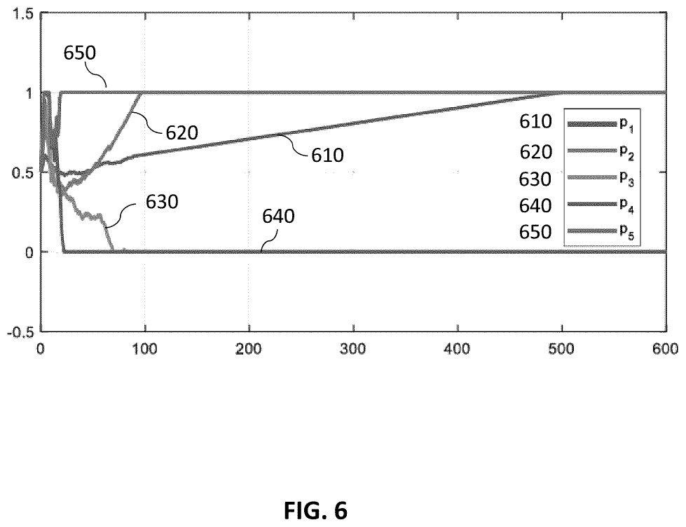

The updated FIG. 6 shows an experimental result of an evolution of the node state probabilities of the five nodes of the stochastic Ising machine 300 for the Ising model of FIG. 1 according to a number of iterations. In this illustrative example, the node state probabilities have been initially set to a same arbitrary value of 0.5. The node state probabilities have further converged toward saturated values, that correspond to one of the stable states (i.e. {θ₁, σ₂, σ₃, σ₄, σ₄}={+1, +1, −1, −1, +1}) mentioned herein before that minimizes the Hamiltonian function. It may be noted that a convergence of the node state probability of the binary node 1 is slower than other binary nodes. This can be due to, once the binary nodes 2 and 5 have reached their stable states, the updated node state probability of node 1 being

$${p}_{1}^{+} = {p}_{1} - γ ( + 3 - 5 - 9 + 10 ) = {p}_{1} - γ ,$$

which directly depends on the value the pre-determined convergence coefficient γ.

As will be described in greater details herein after, one aspect of the present technology is to provide a stochastic Ising machine that may be implemented using conventional digital technology (e.g. CMOS, FPGA). To do so, the developers of the present technology have devised an architecture of a stochastic Ising machine that may be implemented with reduced footprint and thus minimizing a number of components.

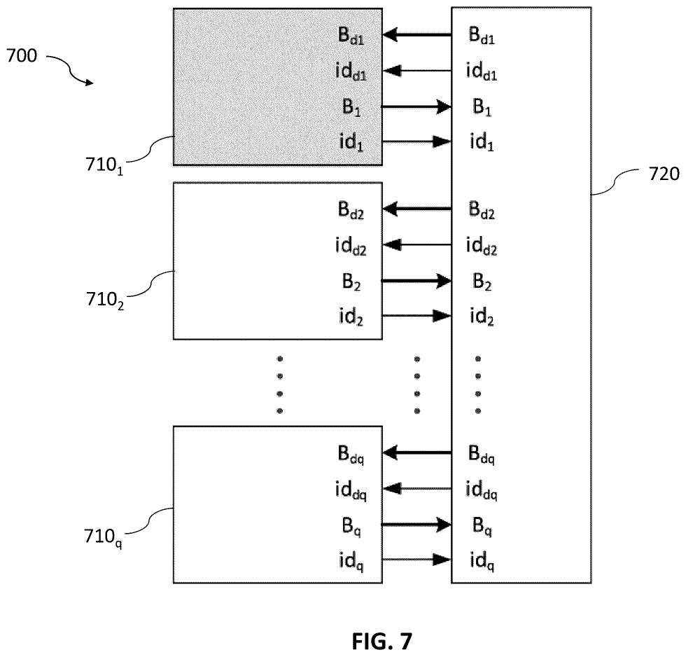

FIG. 7 is a block diagram of a stochastic Ising machine 700 for modeling a stochastic Ising model of N nodes, the stochastic Ising machine 700 including a plurality of node clusters 710ᵢ and an internal communication network 720 for communication information in between the node clusters 710ᵢ. More specifically, each node cluster 710ᵢ determines the node state of a plurality of respective binary nodes. It can be said that the binary nodes of the stochastic Ising machine 700 are partitioned into the plurality of node clusters 710ᵢ. In this example, the stochastic Ising machine 700 includes q nodes clusters, each node cluster determining the node state probabilities of a respective r=N/q binary nodes. It should be noted that stochastic Ising machine 300 is the stochastic Ising machine 700 with N=5 and r=1.

In use, one a given node cluster has determined the updated node state probabilities of its respective binary nodes for the following iteration of the stochastic Ising machine 700, the given node cluster transmits the information about the updated node state probabilities to the internal communication network 720 which transfers it to the other node clusters so that the other cluster nodes may determine the updated node state probabilities of their respective binary nodes based thereon.

For example and without limitation, as shown on FIG. 7, the node cluster 710₁ may receive, from the internal communication network 720, a node state probability vector Bai and a corresponding identifier vector id_{d1}. The node state vector Bai contains a concatenation of the node state (or the node state probabilities) of the binary nodes of another node cluster 710_{i,i≠1}, an identification of the node cluster from which the node state vector Bai being included in the corresponding identifier vector id_{d1}.

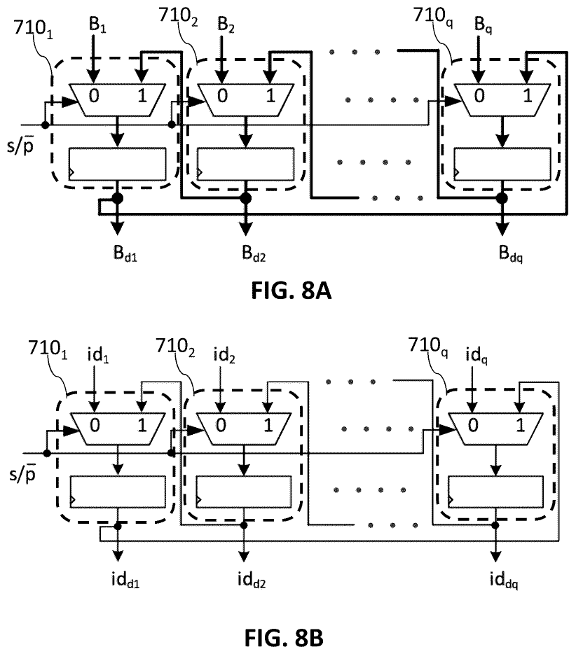

For example, the stochastic Ising machine 700 may include 16 binary nodes partitioned into 4 node clusters, each node cluster including 4 binary nodes. The 4 node clusters generate the updated node state probabilities in parallel and further transmit the updated node state probabilities to the other node clusters along with identifier vectors. As best shown in FIGS. 8A and 8B, once the updated node state probabilities have been determined within the node clusters in parallel, the node state probabilities of a first node cluster are transmitted to a second node cluster during a first clock cycle of the stochastic Ising machine 700, the node state probabilities of the second node cluster are transmitted to a third node cluster during a second clock cycle, the node state probabilities of the third node cluster are transmitted to a fourth node cluster during a third clock cycle and the node state probabilities of the fourth node cluster are transmitted to the first node cluster during a fourth clock cycle. As can be seen on FIGS. 8A and 8B, the stochastic Ising machine 700 has a ring-shaped information transmission structure, but other shapes are contemplated in alternative implementations.

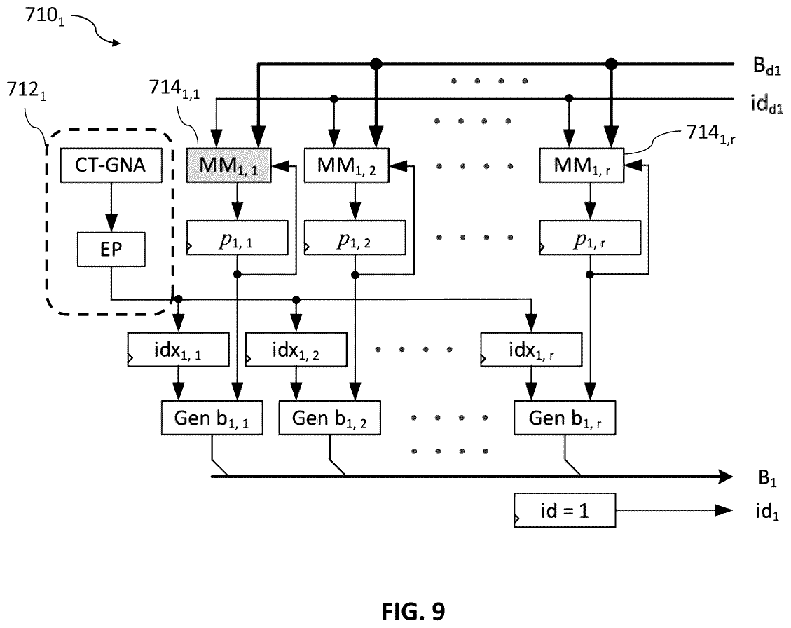

FIG. 9 is a block-diagram of the node cluster 710₁. In an implementation, the node cluster 710₁ includes a SNG 712₁ that may be similar to the SNG 402 described herein before. In use, the SNG 712₁ generates, at each clock cycle, a new random number for a given one of the binary nodes of the node cluster 710₁. In the illustrative example, the SNG 712₁ generates a first random number idx_{1,1} at a first clock cycle, a second random number idx_{1,2} at a second clock cycle subsequent to the first clock cycle, and so on. In an implementation, the random numbers generated by the SNG 712₁ follows a uniform distribution. It should be noted that transmission of information (e.g. node states) between the node clusters may occur during generation of the random numbers by the SNGs 712ᵢ. In other words, a given node cluster may generate a new random number and transmit the updated node states of its respective binary nodes to another node cluster in parallel during a same clock cycle.

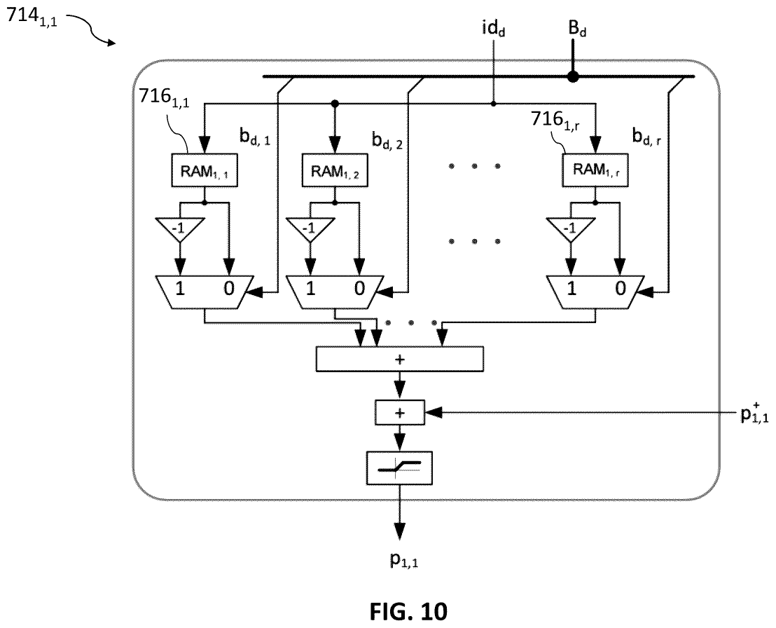

In an implementation, the node cluster 710₁ includes r updating units MM_{1,i}, each computing unit determining, in use, the updated node state probability of a given one of the r nodes of the node cluster 710₁. FIG. 10 is a block diagram of the updating unit MM_{1,1}. The updating unit MM_{1,1} includes a plurality of memory units 716_{1,i} that stores a corresponding interaction coefficient Jui and the pre-determined coefficient convergence coefficient γ. The updating unit MM_{1,1} operates in a similar manner than the updating unit 304₁. In FIG. 10, node states of the binary nodes are referred to as “b_{d,i}”, the node state vector Ba being a concatenation o the node states b_{d,i}.

Once each binary node of the node cluster 710₁ has been provided with a new random number by the SNG 712₁, the node cluster 710₁ generates the bit values for the node sates of the r binary nodes thereof. The same process is also applicable to the other node clusters of the stochastic Ising machine 700. An iteration of the stochastic Ising machine 700 is complete once each node cluster has generated the updated node state probabilities of its corresponding binary nodes. Therefore, a plurality of clock cycles may elapse to execute one iteration of the stochastic Ising machine 700. In this implementation, a new iteration of the stochastic Ising machine 700 is complete every m=max(r, q)+l clock cycles, where l is a computing latency of each of the updating units MM_{i,j}. In some implementations, r equals q. In some other implementations, r may be higher or lower than q.

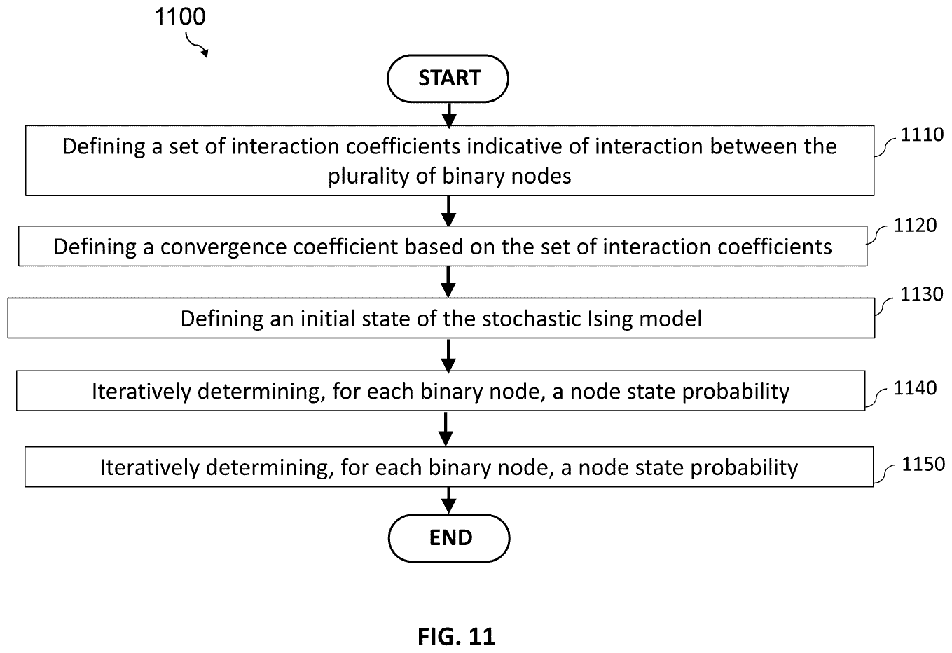

FIG. 11 is a flow diagram of a computer-implemented method 1100 for modeling an Ising model having a plurality of binary nodes according to some implementations of the present technology. In this implementation, the operations of the method 1100 are implemented by the stochastic Ising machine 200, 300, 700. In some implementations, one or more operations of the method 1100 could be implemented, whole or in part, by another computer-implemented device communicably connected to stochastic Ising machine 200, 300, 700. It is also contemplated that the method 1100 or one or more operation thereof may be embodied in computer-executable instructions that are stored in a computer-readable medium, such as a non-transitory mass storage device, loaded into memory and executed by a processor. Some operations or portions of operations in the flow diagram may be possibly being executed concurrently, omitted or changed in order.

The method 1100 may begin with defining, at operation 1110, a set of interaction coefficients indicative of interaction between the plurality of binary nodes. In this implementation, a coefficient of interaction is defined for each pair of binary nodes.

The method 1100 continues with defining, at operation 1120, a convergence coefficient based on the set of interaction coefficients.

The method 1100 continues with defining, at operation 1130, an initial state of the stochastic Ising model. To do so, each binary node may be associated with a node state probability indicative of a probability for the corresponding node to be in a given state at a given iteration of the stochastic Ising model. The initial state of the stochastic Ising model may be defined by setting an initial value of the node state probabilities to a same value (e.g. to 0.5) or different pre-determined values.

The method 1100 continues with iteratively determining, at operation 1140, for each binary node, an updated node state probability indicative of a state of the binary node at a given iteration of the stochastic Ising model based on the set of interaction coefficients, the convergence coefficient, states of the other binary nodes at a previous iteration, and the node state probability of the given node at the previous iteration.

More specifically, in some implementations, the method 1100 further includes, for a given binary node, collecting bit values of the other binary nodes, multiplying the convergence coefficient and the interaction coefficients to corresponding bit values, summing an inverse of the obtained products and summing the node state probability of the given node at the previous iteration to the sum of inverse products. In some implementations, the method 1100 further includes, subsequent to adding the node state probability of the given node at the previous iteration, applying a linear saturation function to the sum.

In some implementations, the method 1100 includes determining, for each binary node, a corresponding bit value at a current iteration of the stochastic Ising model. To do so, the method 1100 may further include, in some implementations, generating, at each iteration of the stochastic Ising model and for each binary node, a random integer by a random number generator. The random integer may further be multiplexed with the node state probability of the given binary node at the previous iteration to obtain the node state probability. In some implementation, the random integer is generated following a uniform probability distribution. For example and without limitations, the random number generator may be a Combined Tausworthe generator.

In the same or other implementations, the method 1100 further includes, prior to multiplexing the random integer with the node state probability of the given node at the previous iteration, extracting, by a priority encoder, a binary representation of an index of a most significant bit of the random integer. The random integer is further adjusted based on the binary representation. For example, the random number may be set equal to the binary representation. The adjusted random number is further multiplexed with the node state probability of the given node at the previous iteration to obtain the updated node state probability.

In some implementations, the method 1100 further includes prior to iteratively determining a node state probability and for each binary node, defining a plurality of node clusters, each node cluster including a subset of the binary nodes. The node clusters may have a same number of binary nodes. In these implementations, the node state probability is determined by, within each node cluster generating, at each iteration, a random integer by a random number generator, each random integer being associated with binary nodes of the node cluster. Once the random number generator of the node cluster has generated a random integer for each binary node of the node cluster, a corresponding random integer is multiplexed, for each binary node of the node cluster, with the node state probability of the given node at the previous iteration to obtain the node state probability.

The method 1100 ends with determining, at operation 1150, saturation values of the node state probabilities of the plurality of binary nodes, the saturation values being indicative of a stable state of the stochastic Ising model in which the Hamiltonian function is minimized, thus providing a solution to a corresponding optimization problem.

As a result, the present disclosure provides stochastic Ising machines suitable for being implemented using conventional digital technology. Thus, unlike alternative Ising machines, the disclosed stochastic Ising machines may operate at room temperature and do not require application-specific hardware equipment.

While the above-described implementations have been described and shown with reference to particular steps performed in a particular order, it will be understood that these steps may be combined, sub-divided, or re-ordered without departing from the teachings of the present technology. At least some of the steps may be executed in parallel or in series. Accordingly, the order and grouping of the steps is not a limitation of the present technology.

It will be appreciated that at least some of the operations of the method 1100 may also be performed by computer programs, which may exist in a variety of forms, both active and inactive. Such as, the computer programs may exist as software program(s) comprised of program instructions in source code, object code, executable code or other formats. Any of the above may be embodied on a computer readable medium, which include storage devices and signals, in compressed or uncompressed form. Representative computer readable storage devices include conventional computer system RAM (random access memory), ROM (read only memory), EPROM (erasable, programmable ROM), EEPROM (electrically erasable, programmable ROM), and magnetic or optical disks or tapes. Representative computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general.

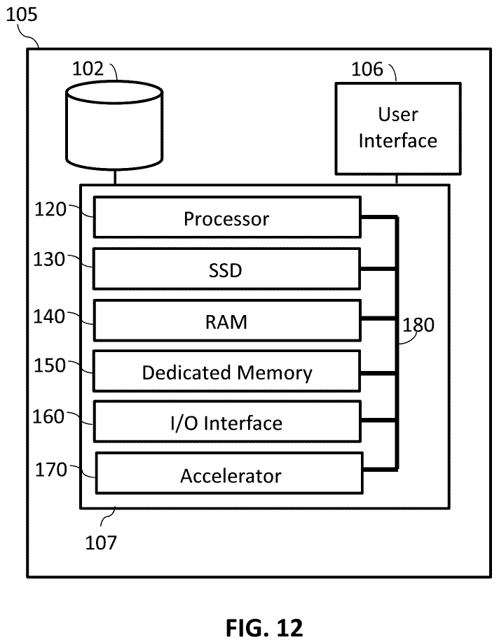

With reference to FIG. 12, there is shown an electronic device 105 in accordance with non-limiting implementations of the present technology. In an embodiment, the stochastic Ising machine 200, 300, 700 may be implemented as the electronic device 105, the electronic device 105 being suitable for executing all functions of the stochastic Ising machine 200, 300, 700, including the functions of the Dedicated Random Number Generating modules, the Weight Stochastic Updating modules and the Multiplexing modules disclosed herein.

The electronic device 105 comprises a computing unit 107. In some implementations, the computing unit 107 may be implemented by any of a conventional personal computer, a controller, and/or an electronic device (e.g., a server, a controller unit, a control device, a monitoring device etc.) and/or any combination thereof appropriate to the relevant task at hand. In some embodiments, the computing unit 107 comprises various hardware components including one or more single or multi-core processors collectively represented by a processor 120, a solid-state drive 130, a RAM 140, a dedicated memory 150 and an input/output interface 160. The computing unit 107 may be a generic computer system.

In some other embodiments, the computing unit 107 may be an “off the shelf” generic computer system. In some embodiments, the computing unit 107 may also be distributed amongst multiple systems. The computing unit 107 may also be specifically dedicated to the implementation of the present technology. As a person in the art of the present technology may appreciate, multiple variations as to how the computing unit 107 is implemented may be envisioned without departing from the scope of the present technology.

Communication between the various components of the computing unit 107 may be enabled by one or more internal and/or external buses 180 (e.g. a PCI bus, universal serial bus, IEEE 1394 “Firewire” bus, SCSI bus, Serial-ATA bus, ARINC bus, etc.), to which the various hardware components are electronically coupled. The one or more internal and/or external buses 180 may perform functions of the internal connexion network 720 of the stochastic Ising machine 700.

The input/output interface 160 may provide networking capabilities such as wired or wireless access. As an example, the input/output interface 160 may comprise a networking interface such as, but not limited to, one or more network ports, one or more network sockets, one or more network interface controllers and the like. Multiple examples of how the networking interface may be implemented will become apparent to the person skilled in the art of the present technology. For example, but without being limitative, the networking interface may implement specific physical layer and data link layer standard such as Ethernet, Fibre Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

According to implementations of the present technology, the solid-state drive 130 stores program instructions suitable for being loaded into the RAM 140 and executed by the processor 120. Although illustrated as a solid-state drive 130, any type of memory may be used in place of the solid-state drive 130, such as a hard disk, optical disk, and/or removable storage media. For example, the memory units 716ij of the stochastic Ising machine 700 may be portions of the RAM 140 and/or of the solid-state drive 130. Parameters of the stochastic Ising model modeled by the stochastic Ising machine 700 may thus be adjusted by adjusting a content of the RAM 140 and/or of the solid-state drive 130.

The processor 120 may be a general-purpose processor, such as a central processing unit (CPU) or a processor dedicated to a specific purpose, such as a digital signal processor (DSP). In some embodiments, the processor 120 may also rely on an accelerator 170 dedicated to certain given tasks. In some embodiments, the processor 120 or the accelerator 170 may be implemented as one or more field programmable gate arrays (FPGAs). Moreover, explicit use of the term “processor”, should not be construed to refer exclusively to hardware capable of executing software, and may implicitly include, without limitation, application specific integrated circuit (ASIC), read-only memory (ROM) for storing software, RAM, and non-volatile storage. Other hardware, conventional and/or custom, may also be included.

Further, the electronic device 105 may include a Human-Machine Interface (HMI) 106. The HMI 106 may include a screen or a display capable of rendering an interface and indications of coded and/or decoded data, and/or any other information suitable for performing the routines and techniques described herein. In this embodiment, the display of the HMI 106 includes and/or be housed with a touchscreen to permit users to input data via some combination of virtual keyboards, icons, menus, or other Graphical User Interfaces (GUIs). The HMI 106 may thus be referred to as a user interface 106. In some embodiments, the display of the user interface 106 may be implemented using a Liquid Crystal Display (LCD) display or a Light Emitting Diode (LED) display, such as an Organic LED (OLED) display. The device may be, for example and without being limitative, a handheld computer, a personal digital assistant, a cellular phone, a network device, a smartphone, a navigation device, an e-mail device, a game console, or a combination of two or more of these data processing devices or other data processing devices. The user interface 106 may be embedded in the electronic device 105 as in the illustrated embodiment of FIG. 11 or located in an external physical location accessible to the user. For example, the user may communicate with the computing unit 107 (e.g. set the values of the convergence coefficient γ and/or the interaction coefficients Jᵢⱼ) by using the user interface 106 wirelessly connected to the computing unit 107. The computing unit 107 may communicate with the user interface 106 via a network (not shown) such as a Local Area Network (LAN) and/or a wireless connexion such as a Wireless Local Area Network (WLAN).

The electronic device 105 may comprise a memory 102 communicably connected to the computing unit 107 for storing received coded data and/or generated decoded data. The memory 102 may be embedded in the electronic device 105 as in the illustrated embodiment of FIG. 11 or located in an external physical location. The computing unit 107 may be configured to access a content of the memory 102 via a network (not shown) such as a Local Area Network (LAN) and/or a wireless connexion such as a Wireless Local Area Network (WLAN).

Needless to say, the computing unit 107 may be implemented in any other suitable hardware, software, and/or firmware, or a combination thereof. In the depicted non-limiting embodiments of the present technology in FIG. 12, the computing unit 107 is a single component. In alternative non-limiting embodiments of the present technology, the functionality of the computing unit 107 may be distributed and may be implemented via multiple components.

Those skilled in the art will appreciate that processor 120 is generally representative of a processing capability that may be provided by, for example, a Central Processing Unit (CPU). In some embodiments, in place of or in addition to one or more conventional CPUs, one or more specialized processing cores may be provided. For example, one or more Graphic Processing Units (GPUs), Tensor Processing Units (TPUs), accelerated processors (or processing accelerators) and/or any other processing unit suitable for executing decoding protocols may be provided in addition to or in place of one or more CPUs. In alternative embodiments, the dedicated memory 140 may be a Random Access Memory (RAM), a Video Random Access Memory (VRAM), a Window Random Access Memory (WRAM), a Multibank Dynamic Random Access Memory (MDRAM), a Double Data Rate (DDR) memory, a Graphics Double Data Rate (GDDR) memory, a High Bandwidth Memory (HBM), a Fast-Cycle Random-Access Memory (FCRAM) or any other suitable type of computer memory.

While the above-described implementations have been described and shown with reference to particular operations performed in a particular order, it will be understood that these operations may be combined, sub-divided, or re-ordered without departing from the teachings of the present technology. At least some of the operations may be executed in parallel or in series. Accordingly, the order and grouping of the operations is not a limitation of the present technology.

Those of ordinary skill in the art will realize that the descriptions of various embodiments are illustrative only and are not intended to be in any way limiting. Other implementations will readily suggest themselves to such persons with ordinary skill in the art having the benefit of the present disclosure. Furthermore, at least some of the disclosed implementations may be customized to offer valuable solutions to existing needs and problems related to optimization problems mapped by an Ising model. In the interest of clarity, not all of the routine features of the implementations of the at least some of the disclosed embodiments are shown and described.

In particular, combinations of features are not limited to those presented in the foregoing description as combinations of elements listed in the appended claims form an integral part of the present disclosure. It will, of course, be appreciated that in the development of any such actual implementation of the at least some of the disclosed embodiments, numerous implementation-specific decisions may need to be made in order to achieve the developer's specific goals, such as compliance with application-, system-, and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of digital error correction having the benefit of the present disclosure.

In accordance with the present disclosure, the components, process operations, and/or data structures described in herein may be implemented using various types of operating systems, computing platforms, network devices, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used. Where a routine including a series of operations is implemented by a computer, a processor operatively connected to a memory, or a machine, those operations may be stored as a series of instructions readable by the machine, processor or computer, and may be stored on a non-transitory, tangible medium.

Systems and modules described herein may comprise software, firmware, hardware, or any combination(s) of software, firmware, or hardware suitable for the purposes described herein. Software and other modules may be executed by a processor and reside on a memory of servers, workstations, personal computers, computerized tablets, personal digital assistants (PDA), and other devices suitable for the purposes described herein. Software and other modules may be accessible via local memory, via a network, via a browser or other application or via other means suitable for the purposes described herein. Data structures described herein may comprise computer files, variables, programming arrays, programming structures, or any electronic information storage schemes, routine and techniques, or any combinations thereof, suitable for the purposes described herein.

It should be expressly understood that not all technical effects mentioned herein need to be enjoyed in each and every embodiment of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A computer-implemented method for modeling a stochastic Ising model comprising a plurality of binary nodes, the method comprising:
defining a set of interaction coefficients indicative of interaction between the plurality of binary nodes;
defining an initial state of the stochastic Ising model;
iteratively determining, for each binary node, a node state probability indicative of a state of the binary node at a given iteration of the stochastic Ising model based on the set of interaction coefficients, states of the other binary nodes at a previous iteration, and the node state probability of the given binary node at the previous iteration; and
determining saturation values of the node state probabilities of the plurality of binary nodes.

2. The method of claim 1, further comprising, prior to iteratively determining the node state probability, defining a convergence coefficient based on the set of interaction coefficients, the iterative determination of the node state probability being further based on the convergence coefficient.

3. The method of claim 1, wherein determining a node state probability comprises, at each iteration and for each binary node:
generating, by a random number generator, a random integer; and
multiplexing the random integer with the node state probability of the given binary node at the previous iteration to obtain the node state probability.

4. The method of claim 3, wherein the random integer is generated following a uniform probability distribution.

5. The method of claim 3, wherein the random number generator is a Combined Tausworthe generator.

6. The method of claim 3, further comprising, prior to multiplexing the random integer with the node state probability of the given binary node at the previous iteration:
extracting, by a priority encoder, a binary representation of an index of a most significant bit of the output of the random number generator to adjust the random integer; and
multiplexing the adjusted random integer with the node state probability of the given binary node at the previous iteration to obtain the node state probability.

7. The method of claim 2, wherein determining a node state probability comprises, at each iteration and for each binary node:
collecting bit values of the other binary nodes;
multiplying the convergence coefficient and the interaction coefficients to corresponding bit values;
summing an inverse of the obtained products; and
summing the node state probability of the given binary node at the previous iteration to the sum of inverse products.

8. The method of claim 7, further comprising, subsequent to adding the node state probability of the given binary node at the previous iteration, applying a linear saturation function to the sum.

9. The method of claim 1, further comprising, prior to iteratively determining a node state probability for each binary node:
defining a plurality of node clusters, each node cluster comprising a subset of the binary nodes, the node clusters having a same number of binary nodes,
and wherein determining a node state probability comprises, within each node cluster:
generating, at each iteration, a random integer by a random number generator, each random integer being associated with binary nodes of the node cluster; and
once the random number generator of the node cluster has generated a random integer for each binary node of the node cluster, multiplexing, for each binary node of the node cluster, a corresponding random integer with the node state probability of the given binary node at the previous iteration to obtain the node state probability.

10. The method of claim 1, wherein defining an initial state of the stochastic Ising model comprises assigning the node state probabilities to a pre-determined probability value.

11. A stochastic Ising machine for numeric modeling a stochastic Ising model comprising a plurality of binary nodes, the application-specific hardware equipment comprising:
a processor configured to associate each binary node with a node state probability indicative of a state of the binary node at a given iteration;
a memory communicably connected to the processor and configured to store information about:
a set of interaction coefficients indicative of interaction between the plurality of binary nodes, and
an initial state of the stochastic Ising model by assigning an initial bit value to each of the binary node,
one or more random number generators operated by the processor and configured to generate random integers;
one or more multiplexing modules, each multiplexing module being configured to iteratively multiplex a random integer, generated by a random number generator associated with the multiplexer, with the node state probability of a corresponding binary node at the previous iteration to obtain the node state probability of the corresponding node.

12. The stochastic Ising machine of claim 11, wherein the one or more random number generator are Combined Tausworthe generators.

13. The stochastic Ising machine of claim 11, wherein each random number generator further comprises a priority encoder configured to generate a binary representation of an index of a most significant bit of the random integer, the multiplexer associated with the random number generator being configured to multiplex the binary representation with the node state probability of the corresponding node at the previous iteration to obtain the node state probability thereof.

14. The stochastic Ising machine of claim 11, wherein the memory is further configured to store information about a convergence coefficient defined based on the set of interaction coefficients.

15. The stochastic Ising machine of claim 14, wherein the processor is further configured to, for each binary node:
collect bit values of the other binary nodes;
apply the convergence coefficient and the interaction coefficients to corresponding bit values to obtain interaction values;
sum an inverse of the interaction values; and
sum the node state probability of the given binary node at the previous iteration to the sum of inverse interaction values.

16. The stochastic Ising machine of claim 15, wherein the processor is further configured to, for each binary node and subsequent to adding the node state probability of the given binary node at the previous iteration, apply a linear saturation function to the sum.

17. The stochastic Ising machine of claim 11, wherein the processor is further configured to:
define a plurality of node clusters, each node cluster comprising a subset of the binary nodes, the node clusters having a same number of binary nodes;
cause, at each iteration, a given random number generator of the one or more random number generators, to generate a random integer; and
once the random number generator has generated a random integer for each binary node of a corresponding node cluster, cause multiplexers of the binary nodes of the node cluster to multiplex a corresponding random integer with the node state probability of the corresponding binary node at a previous iteration to obtain the node state probability.

18. The stochastic Ising machine of claim 11, further comprising
a plurality of memory units communicably connected with the processor, each memory unit being configured to store an interaction coefficient of a first binary node on a second binary node.

19. A stochastic Ising machine for numeric modeling a stochastic Ising model comprising a plurality of binary nodes, the application-specific hardware equipment comprising a processor and a memory storing a plurality of executable instructions which, when executed by the processor, cause the application-specific hardware equipment to perform the method of claim 1.

20. A non-transitory computer-readable medium comprising computer-readable instructions that, upon being executed by a system, cause the system to perform the method of claim 1.
